(19) United States
(12) Patent Application Publication
(10) Pub. No.: US 2010/0274856 A1
(43) Pub. Date: Oct. 28, 2010

(54) MANAGING OVERSIZED MESSAGES

(75) Inventors: VIJAY K. BHADRIRAJU, DURHAM, NC (US); DONNIE A. SMITH, Jr., RALEIGH, NC (US)

Correspondence Address: LAW OFFICE OF JIM BOICE, 3839 BEE CAVE ROAD, SUITE 201, WEST LAKE HILLS, TX, 78746, US

(73) Assignee: INTERNATIONAL BUSINESS MACHINES CORPORATION, ARMONK, NY (US)

(21) Appl. No.: 12/429,656

(22) Filed: Apr. 24, 2009

(51) Int. Cl. G06F 15/16

(52) U.S. Cl. 709/206

(57) ABSTRACT

A query is sent, from a message sender to a message recipient, asking for a maximum size of incoming messages that is acceptable to the message recipient. If a proposed message from the message sender to the message recipient exceeds the maximum size, then the proposed message is ameliorated by size before being sent to the message recipient.

### BACKGROUND

The present disclosure relates to the field of computers, and specifically to message between computers. Still more particularly, the present disclosure relates to oversized messages.

Networks provide computer users with the ability to communicate using computer messaging. One type of computer messaging is email, which is the most common communication medium used in business today. Furthermore, email attachments provide a convenient means for businesses and people to exchange documents with one another. Thus, email gives senders the ability to transmit both messages, written within the body of the email, as well as attached documents.

### BRIEF SUMMARY

A query is sent, from a message sender to a message recipient, asking for a maximum size of incoming messages that is acceptable to the message recipient. If a proposed message from the message sender to the message recipient exceeds the maximum size, then the proposed message is ameliorated by size before being sent to the message recipient.

### BRIEF DESCRIPTION OF THE SEVERAL VIEWS OF THE DRAWINGS

FIG. 1 depicts an exemplary computer in which the present invention may be implemented;

FIG. 2 illustrates an exemplary messaging network and messages used in an embodiment of the present invention;

FIG. 3 depicts an exemplary graphical user interface (GUI) that is presented to a sender message client using the present invention; and

FIG. 4 is a high-level flow-chart of exemplary steps processed by a computer to manage oversized electronic messages.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

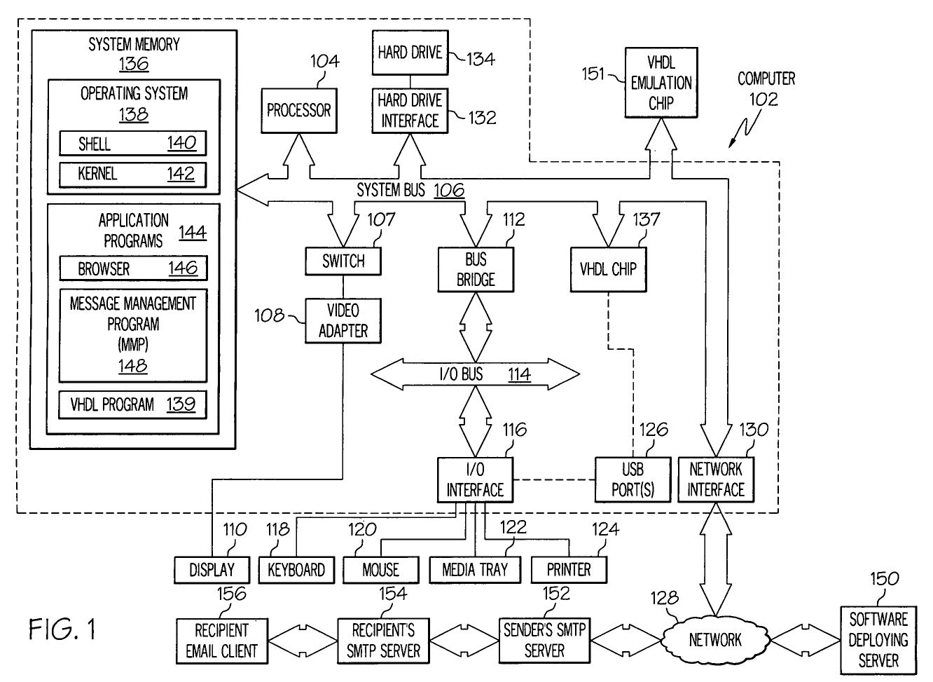

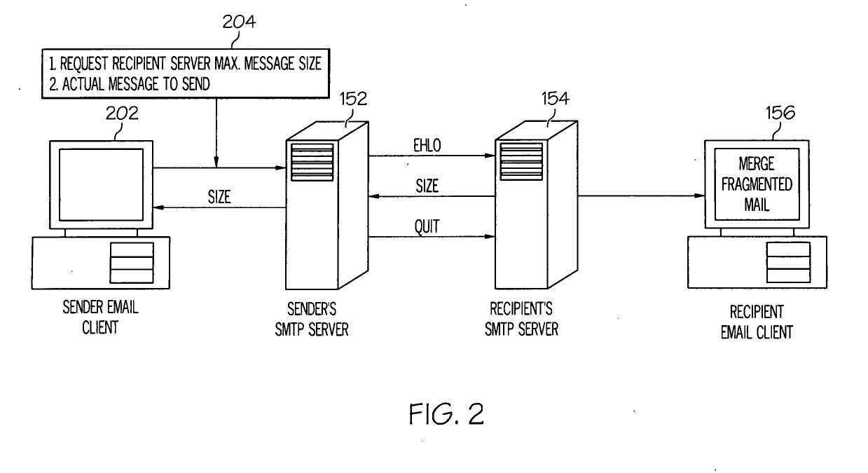

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150, sender's SMTP server 152, recipient's SMTP server 154, and/or recipient email client 156. Note also that computer 102 may be utilized as sender email client 202 shown below in FIG. 2.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., message management program—MMP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, computer 102 is able to communicate with a software deploying server 150 and a sender's SMTP server 152 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

Application programs 144 in computer 102's system memory (as well as software deploying server 150's system memory) also include a message management program (MMP) 148. MMP 148 includes code for implementing the processes described below, including those described in FIGS. 2-4. In one embodiment, computer 102 is able to download MMP 148 from software deploying server 150, including in an on-demand basis. Note further that, in one embodiment of the present invention, software deploying server 150 performs all of the functions associated with the present invention (including execution of MMP 148), thus freeing computer 102 from having to use its own internal computing resources to execute MMP 148.

Also stored in system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from MMP 148 causes VHDL program 139 to configure VHDL chip 137, which may be an FPGA, ASIC, etc.

In another embodiment of the present invention, execution of instructions from MMP 148 results in a utilization of VHDL program 139 to program a VHDL emulation chip 151. VHDL emulation chip 151 may incorporate a similar architecture as described above for VHDL chip 137. Once MMP 148 and VHDL program 139 program VHDL emulation chip 151, VHDL emulation chip 151 performs, as hardware, some or all functions described by one or more executions of some or all of the instructions found in MMP 148. That is, the VHDL emulation chip 151 is a hardware emulation of some or all of the software instructions found in MMP 148. In one embodiment, VHDL emulation chip 151 is a programmable read only memory (PROM) that, once burned in accordance with instructions from MMP 148 and VHDL program 139, is permanently transformed into a new circuitry that performs the functions needed to perform the process described below in FIGS. 2-4.

As described in further detail below, sender's SMTP server 152, recipient's SMTP server 154, computer 102 (shown as sender email client 202 in FIG. 2), and/or recipient email client 156 are able to communicate, preferably via a network such as 128. Thus, while network 128 is only shown between computer 102 and sender's SMTP server 152, it is to be understood that a similar network (not shown) may also exist between sender's SMTP server 152, recipient's SMTP server 154, and/or recipient email client 156. Note further that while sender's SMTP server 152 and recipient's SMTP server 154 are described as simple mail transfer protocol (SMTP) servers, the scope of the present invention in one or more embodiments is understood to include any format message and/or mail servers including, but not limited to, the SMTP format.

In one embodiment of the present invention, the architecture presented in FIG. 1 is used as a system for managing oversized messages. In one embodiment, a combination of network interface 130 and processor 104 function as a query transmission logic for transmitting a query to a recipient message server, wherein the query is transmitted to determine a maximum permissible size for a message to a recipient; instructing logic for, in response to determining that the message is too large for the recipient, instructing a message sender to ameliorate the message before transmitting the message from a message sender, wherein ameliorating the message creates an ameliorated message that is smaller than the maximum permissible size; and ameliorated message transmission logic for transmitting the ameliorated message to the recipient. In one embodiment, all such logic is located within sender's SMTP server 152. In another embodiment, all such logic is located within sender email client 202, sender's SMTP server 152, recipient's SMTP server 154, or recipient email client 156, or is within a combination of some or all of these devices.

Similarly, in one embodiment processor 104 functions as a transmission withholding logic for withholding transmission of the ameliorated message to the recipient; and a combination of network interface 130 and processor 104 function as additional transmission logic for transmitting the ameliorated message to other recipients that each have a larger permissible message size as well as for performing other message transmission operations.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

Email services utilise email servers. In one embodiment of the present invention, such email servers use the simple message transfer protocol (SMTP) to facilitate communications between themselves and other email servers, and thus utilizes SMTP servers such as sender's SMTP server 152 and recipient's SMTP server 154 shown in FIG. 2. The SMTP model is based on a two-way communication session between an SMTP-server (e.g., sender's SMTP server 152 or recipient's SMTP server 154) and an SMTP-client (e.g., sender email client 202 and recipient email client 156 to their respective sender's SMTP server 152 or recipient's SMTP server 154). Note that in one embodiment sender email client 202 is computer 102 shown in FIG. 1.

Extended simple mail transfer protocol (ESMTP) extends the SMTP protocol to provide support for additional file types and enhance security. ESMTP also provides a mechanism for determining the maximum message size the SMTP-server will accept. An SMTP-server, such as recipient's SMTP server 154, which supports the Extended SMTP protocol, can reply back to an extended “Hello” (EHLO) command with a SIZE keyword. The SIZE keyword indicates the maximum message size message that a receiver (i.e., recipient's SMTP server 154 on behalf of recipient email client 156) will accept.

For example, assume sender email client 202 wants to send a message 204 to a recipient email client 156. In accordance with the present invention, a novel message 204 includes two parts. The first part is a SIZE query to the recipient's SMTP server 154. This request may be prompted by the second part of the message (the actual message and any attachments) exceeding some pre-determined size that has been set by the sender email client 202. For example, assume that the size of the second part of email message 204 (the actual message and any attachments) being sent is 3000 bytes. If so, then the sender email client 202 initiates two communication sessions between the sender's SMTP server 152 and recipients' SMTP server 154. The first session is used to learn the maximum allowable size for emails that are sent to the recipient email client 156. (Note that different email clients that use recipient's SMTP server 154 may have different maximum sizes for each email that they receive.)

Thus, for the first session, the sender email client 202 instructs the sender's SMTP server 152 to initiate a conversation with recipient's SMTP server 154, which belongs to an enterprise identified at abc.com. In one embodiment, the conversation between the sender's SMTP server 152 and the recipient's SMTP server 154 is initiated with an EHLO command asking for the maximum size email that the recipient email client 156 can receive. The recipient's SMTP server 154 for abc.com replies back with a SIZE keyword to the sender's SMTP server 152 and the sender email client 202, indicating that the maximum message size that the recipient email client 156 will accept is 1500 as illustrated below.

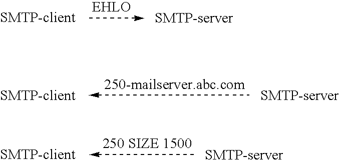

The Sender's SMTP server 152, having now learned that the maximum size email that the recipient email client 156 can receive is 1500 bytes, then uses a QUIT command to terminate the conversation between the sender's SMTP server 152 and the recipient's SMTP server 154 without sending the actual email message. As part of the instruction to the sender's SMTP server 152 to issue the QUIT command after issuing the EHLO command, a Sender email program (i.e., part of MMP 148 shown in FIG. 1 as within computer 102 and/or within sender's SMTP server 152) used by sender email client 202 includes a keyword in the TO: header. This keyword is set by a sender SMTP administrator. As example of such a keyword is SIZE_QUERY. This keyword is added as the first recipient in the TO: header as illustrated below.

TO: SIZE_QUERY, john_smith abc.com

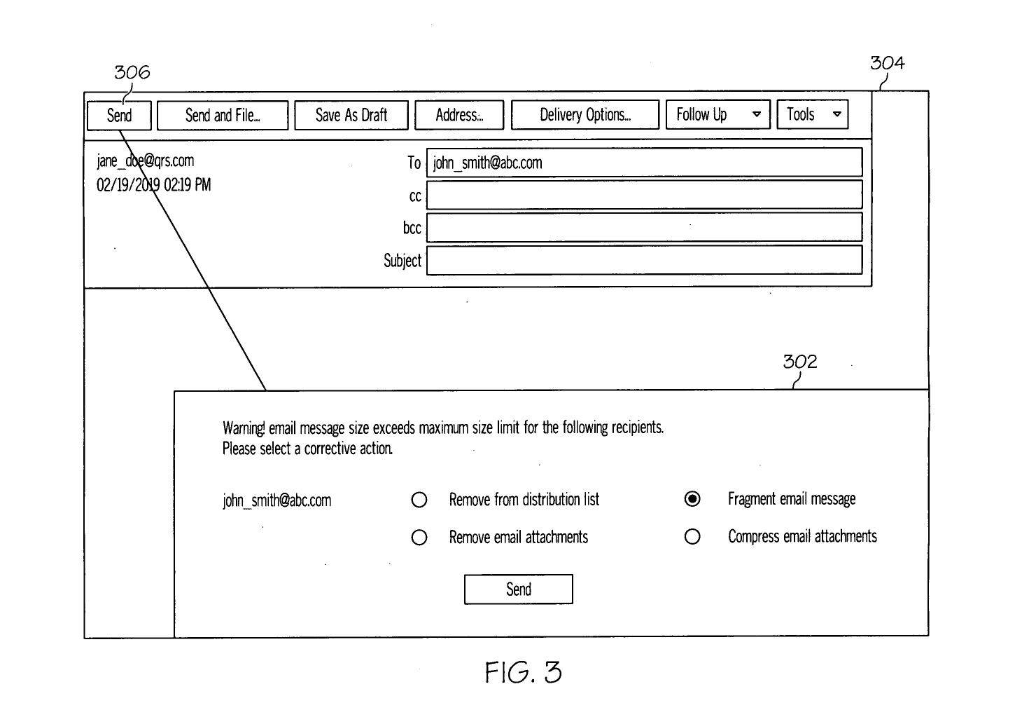

The sender SMTP server 152 then communicates the maximum message size back to the sender email program for each intended message recipient. If the size of the message exceeds the maximum message size for one or more recipients, the sender email program displays a pop-up containing the list of recipients whose maximum message size is too small to receive the email message. An exemplary pop-up window 302 is shown in the email graphical user interface (GUI) 304 shown in FIG. 3. The pop-up window 302 appears when the user clicks the “send” button 306. Note, however, that actually sending the email message is delayed until the sender addresses the warning shown in the pop-up window 302. Thus, pop-up window 302 provides the sender with the option of removing the recipient from the distribution list, to fragment (break apart) the email message into multiple email messages, to remove any email attachments, or to compress any email attachments, as illustrated in FIG. 3. If the sender elects to remove or compress any email attachments, the process described above reiterates in a recursive manner until the email and all attachments fall below the maximum allowable size message that is acceptable to the recipient, or else until the conclusion is reached that the size will never be small enough for a particular recipient, who is then removed from the distribution list.

If the sender chooses the option to fragment an email message, a sender email program (part of MMP 148 shown in FIG. 1) will break apart the email message into smaller email messages and automatically send the fragmented parts as individual email messages. The fragmented parts will be reassembled by a Recipient email program (also part of MMP 148 shown in FIG. 1, but preferably located within recipient email client 156 and/or recipient's email server 154) into a single email message.

In one embodiment, implementing the process described above is accomplished by extending the SMTP protocol to include a set of additional headers for indicating that an original email message has been fragmented and the fragmenting algorithm used to break apart the original email message. Additional headers may also indicate the number of fragmented email messages belonging to the original email message, a unique identifier for associating the fragmented email messages with one another, and the fragmented order of the original email message. Examples of such new headers are described in the following paragraphs.

In one example, an original email message being sent to john_smith abc.com has been broken into two fragmented email messages by a Sender email program. The FRAG ID header is used to link the first and second fragmented email messages. The FRAGED MESSAGES header indicates the number of fragmented email messages comprising the original email message. The FRAG NO header indicates the order in which the fragmented email messages should be reassembled. The FRAG ALGORITHM header is used to specify the algorithm used to break apart the original email message and subsequently the one required to reassemble the fragmented email messages into the original email message. Thus, exemplary email headers for two fragments of an original email message may appear as:

TO: john_smith@abc.com
FROM: jane_doe@qrs.com
DATE: Tues 19 February 2019 02:19:00
FRAG ID: 1234567890
FRAG NO: 1
FRAGED MESSAGES: 2
FRAG ALGORITHM: xyz
TO: john_smith@abc.com
FROM: jane_doe@qrs.com
DATE: Tues 19 February 2019 02:19:00
FRAG ID: 1234567890
FRAG NO: 2
FRAGED MESSAGES: 2
FRAG ALGORITHM: xyz

The recipient email program examines the headers of all incoming email messages to determine if an email message is a fragmented message, which is a component of a larger complete email message. If an email message is a fragmented email message, it will not be placed in the recipient's inbox until all the fragments of the larger complete email message are merged. The recipient email program merges the fragmented email message with other fragmented email messages with the same FRAG ID to create the original larger complete email message. Once the original larger complete email message has been reassembled, it will be placed in the recipient's inbox.

In an alternative embodiment, the SMTP protocol instructions are added to the SUBJECT header as illustrated below:

```
    TO: john_smith@abc.com
    FROM: jane_doe@qrs.com
    DATE: Tues 19 February 2019 02:19:00
    SUBJECT: FRAG ID: 1234567890,
    FRAG NO: 1, FRAGED MESSAGES: 2,
FRAG ALGORITHM: xyz, Original Subject Goes Here
    TO: john_smith@abc.com
    FROM: jane_doe@qrs.com
    DATE: Tues 19 February 2019 02:19:00
    SUBJECT: FRAG ID: 1234567890,
    FRAG NO: 2, FRAGED MESSAGES: 2,
FRAG ALGORITHM: xyz, Original Subject Goes Here
```

Thus, the recipient email program examines the SUBJECT header of all incoming email messages to determine whether fragmented email messages are part of the larger original complete email message. In either implementation (with the fragmentation information being above or within the SUBJECT header), if an original email message has been fragmented, it will not be placed in the recipient's inbox until the fragmented email messages are merged with other fragmented email messages having the same FRAG ID to create the original email message. The recipient email program then removes all FRAG* headers from the SUBJECT header. Once the original email message has been reassembled, it is placed in the recipient's inbox.

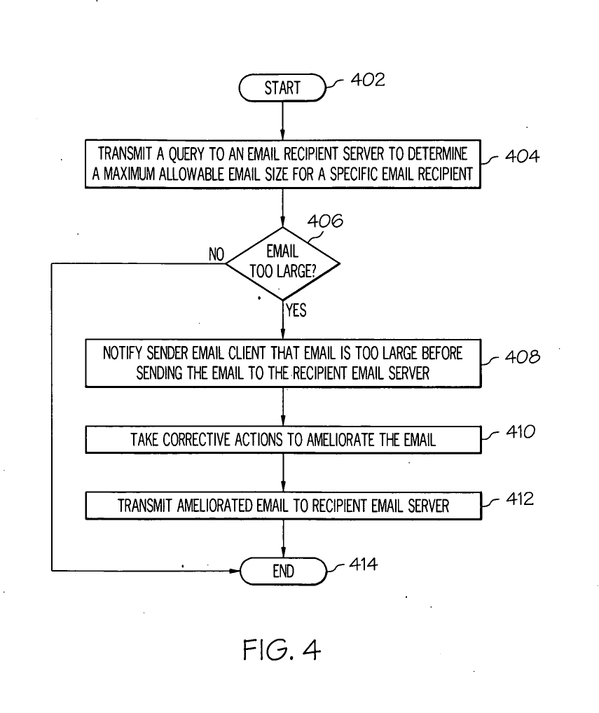

With reference now to FIG. 4, a high-level overview of the present invention is presented. Initiator block 402 may be prompted by a sender initiating a transmission of an email message to one or more specific recipients, wherein the size of the email message (plus any attachments) exceeds a pre-determined level set by the sender. Alternatively, initiator block 402 may be prompted every time the sender initiates the transmission of the email to one or more recipients, regardless of the size of the email and any attachments. As shown in block 404, a query, which was initiated by an email sender (e.g., sender email client 202 shown in FIG. 2), is sent from a sender email server (e.g., sender's SMTP server 152) to a recipient email server (e.g., recipient's SMTP server 154) asking for the maximum size email that can be received by one or more recipients (e.g., recipient email client 156) serviced by the recipient email server. Note that this request is performed before the email message (and any attachments) is actually sent, and is preferably sent in a stand-alone session that terminates before actually sending the email message and attachments.

After the recipient email server responds with the maximum size email that is acceptable for a specific email recipient, the sender determines if that maximum size has been exceeded (query block 406). If not, then the message is sent with no modification and the process ends at terminator block 414. However, if the email and attachments are too large, then the email sender (e.g., sender email client 202) is so notified (block 408), and corrective steps are taken (block 410), either at the sender email client 202 or at the sender's SMTP server 152 shown in FIG. 2. Examples of such corrective steps are described above, and include, but are not limited to, removing attachments from the email, fragmenting the email message itself and/or any attachments, compressing the email attachments, and/or any combination of such measures. In one embodiment, the email message is simply cancelled for one or more identified recipients. Preferably, however, the ameliorated (attachment-excised, fragmented, compressed) message is then sent to the recipient, assuming that the ameliorated message now falls below the maximum size restriction of the recipient. If the ameliorated message is still too large, then other corrective actions are taken in step 410 in a recursive manner until 1) the message is small enough or 2) all available reduction processes have been performed and the message is still too large, thus resulting in the email being removed from the outbound message queue of the sender. The process ends at terminator block 414.

Note that in an embodiment of the invention, substantive operations may be performed by a server, shown in exemplary manner as sender's SMTP server 152 and/or recipient's SMTP server 154 in FIG. 4. Thus, in one embodiment of the invention a server comprises a receiver for receiving a query, wherein the query is transmitted from a sender to determine a maximum permissible size for a message to a recipient. An exemplary receiver comprises network interface 130 and processor 104 shown in FIG. 1. The server may also comprise amelioration logic for ameliorating the message before transmitting the message to the recipient, wherein ameliorating the message creates an ameliorated message that is smaller than the maximum permissible size. Exemplary amelioration logic comprises processor 104 and MMP 148 shown in FIG. 1. Furthermore, such as server may comprise transmission logic for transmitting said ameliorated message to the recipient. Exemplary transmission logic comprises processor 104, system bus 106, and network interface 130 shown in FIG. 1.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A computer-implemented method of transmitting a message from a sender to a recipient, the computer-implemented method comprising:
transmitting a query to a recipient's message server, wherein the query is transmitted to determine a maximum permissible size for a message to the recipient;
ameliorating the message before transmitting the message to the recipient in response to determining that the message is too large for the recipient, wherein ameliorating the message creates an ameliorated message that is smaller than the maximum permissible size; and
transmitting said ameliorated message to the recipient.

2. The computer-implemented method of claim 1, wherein the message is an email message with an attachment, and wherein ameliorating the message comprises:
fragmenting the attachment into multiple parts; and
combining each of the multiple parts as an attachment to a separate email message to the recipient, wherein each of the multiple parts combined with a corresponding separate email message is smaller than the maximum permissible size.

3. The computer-implemented method of claim 1, wherein the message is an email message with an attachment, and wherein ameliorating the message comprises compressing the attachment to create a compressed attachment, wherein the email message and the compressed attachment together are smaller than the maximum permissible size.

4. The computer-implemented method of claim 1, wherein the message is an email message with an attachment, and wherein ameliorating the message comprises removing the attachment from the email message.

5. The computer-implemented method of claim 1, wherein the ameliorated message still exceeds the maximum permissible size after being ameliorated, and wherein the computer-implemented method further comprises:
withholding transmission of the ameliorated message to the recipient; and
transmitting the ameliorated message to a second recipient that will accept a message that is larger than the maximum permissible size for the recipient.

6. The computer-implemented method of claim 5, wherein the recipient and the second recipient are serviced by a same server.

7. The computer-implemented method of claim 1, wherein the query and response to determine the maximum permissible size for the message for the recipient is communicated during a first communication session between a sender's message server and the recipient's message server, and wherein transmitting the ameliorated message to the recipient is performed during a second communication session between the sender's message server and the recipient's message server after the first session has ended.

8. A computer program product comprising a computer readable storage medium embodied therewith, the computer readable storage medium comprising:
computer readable program code configured to transmit a query to a recipient's message server, wherein the query is transmitted to determine a maximum permissible size for a message to a recipient;
computer readable program code configured to ameliorate the message before transmitting the message to the recipient in response to determining that the message is too large for the recipient, wherein the ameliorated message is smaller than the maximum permissible size; and
computer readable program code configured to transmit the ameliorated message to the recipient.

9. The computer program product of claim 8, wherein the message is an email message with an attachment, and wherein the computer readable program code configured to ameliorate the message comprises:
computer readable program code configured to fragment the attachment into multiple parts; and
computer readable program code configured to combine each of the multiple parts as an attachment to a separate email message to the recipient, wherein each of the multiple parts combined with a corresponding separate email message is smaller than the maximum permissible size.

10. The computer program product of claim 8, wherein the message is an email message with an attachment, and the computer readable program code configured to ameliorate the message comprises computer readable program code configured to compress the attachment to create a compressed attachment, wherein the email message and the compressed attachment are smaller than the maximum permissible size.

11. The computer program product of claim 8, wherein the message is an email message with an attachment, and wherein the computer readable program code configured to ameliorate the message comprises computer readable program code configured to remove the attachment from the email message.

12. The computer program product of claim 8, wherein the ameliorated message still exceeds the maximum permissible size after being ameliorated, and wherein the computer readable storage medium comprises:
computer readable program code configured to withhold transmission of the ameliorated message to the recipient; and
computer readable program code configured to transmit the ameliorated message to a second recipient that has a larger permissible message size.

13. The computer program product of claim 8, wherein the query and response to determine the maximum permissible size for the message for the recipient is communicated during a first communication session between a sender's message server and the recipient's message server, and wherein computer readable program code configured to transmit the ameliorated message to the recipient is performed during a second communication session between the sender's message server and the recipient's message server after the first session has ended.

14. The computer program product of claim 8, wherein the computer program product is downloaded from a software deploying server in an on-demand basis.

15. A server comprising:
a receiver for receiving a query, wherein the query is transmitted from a sender to determine a maximum permissible size for a message to a recipient;
amelioration logic for ameliorating the message before transmitting the message to the recipient, wherein ameliorating the message creates an ameliorated message that is smaller than the maximum permissible size; and
transmission logic for transmitting said ameliorated message to the recipient.

16. The server of claim 15, wherein the message is an email message with an attachment, and wherein ameliorating the message comprises:
fragmenting the attachment into multiple parts; and
combining each of the multiple parts as an attachment to a separate email message to the recipient, wherein each of the multiple parts combined with a corresponding separate email message is smaller than the maximum permissible size.

17. The server of claim 15, wherein the message is an email message with an attachment, and wherein ameliorating the message comprises compressing the attachment to create a compressed attachment, wherein the email message and the compressed attachment together are smaller than the maximum permissible size.

18. The server of claim 15, wherein the message is an email message with an attachment, and wherein ameliorating the message comprises removing the attachment from the email message.

19. The server of claim 15, wherein the ameliorated message still exceeds the maximum permissible size after being ameliorated, and wherein, and wherein ameliorating the message comprises:
withholding transmission of the ameliorated message to the recipient; and
transmitting the ameliorated message to a second recipient that will accept a message that is larger than the maximum permissible size for the recipient.

20. The server of claim 15, wherein the server is a sender's e-mail server, wherein the query to determine the maximum permissible size for the message for the recipient is communicated during a first communication session between the sender's e-mail server and a recipient's email server, and wherein the ameliorated message is transmitted to the recipient during a second communication session between the sender's email server and the recipient's email server after the first session has ended.
